(19) United States
(12) Patent Application Publication
(10) Pub. No.: US 2024/0333051 A1
(43) Pub. Date: Oct. 3, 2024

(54) STATOR COOLING DUCTS HAVING FORCED VORTEXES

(71) Applicant: Schaeffler Technologies AG & Co. KG, Herzogenaurach (DE)

(72) Inventors: Kornelius Wiegert, Achern (DE); Benno De Brouwer, Würselen (DE)

(21) Appl. No.: 18/682,109

(22) PCT Filed: Jul. 14, 2022
(86) PCT No.: PCT/DE2022/100503

§ 371 Date: Feb. 7, 2024

(30) Foreign Application Priority Data
Aug. 10, 2021 (DE) 10 2021 120 773.8

(51) Int. Cl. H02K 1/20

(52) U.S. Cl. CPC H02K 1/20; H02K 2213/03

(57) ABSTRACT

The invention relates to an active component (1) of an electric machine, comprising a cooling duct (2), at least some portions of which have a substantially axial extent (3) having a substantially constant cross-sectional area (4), wherein a reducing element (5) that protrudes into the extent is designed to reduce the cross-sectional area (4) in such a way that vortexes are created in a cooling fluid that flows therethrough. The invention further relates to an electric machine.

### CROSS-REFERENCE TO RELATED APPLICATION

The present application is the U.S. National Phase of PCT Patent Application Number PCT/DE2022/100503, filed on Jul. 14, 2022, which claims priority to German Patent Application Number 10 2021 120 773.8, filed on Aug. 10, 2021, the entire disclosures of which are incorporated by reference herein.

### TECHNICAL FIELD

The present disclosure relates to an active component of an electric machine and the electric machine as such.

### BACKGROUND

To increase the continuous power of electric machines, they can be actively cooled using a cooling medium, namely in particular oil or water or WEG. One possibility here is to provide an active component of the electric machine with cooling holes and to flow the cooling medium directly therethrough. For the purposes of the application, an active component is understood to be a stator or a rotor of the electric machine, since these components are viewed as active in the conversion of electrical to mechanical energy.

The publication DE102019215474 discloses a laminated stator having cooling channels, which are designed as tubes and also take on the function of tie rods. The tubes run axially through the laminated core and can be connected via connections in the end plates to form an overall meandering cooling system.

The publication DE102019216125 A1 shows a laminated stator having axially extending cooling channels in a sheet metal section, wherein the cooling channels are connected to one another via end disks arranged on the front side. Cooling medium is supplied via a pipe connected to the end disks, and is drained via outlet channels to the winding heads of the stator.

In the publication US2018054094 AA and in US 2019/0006914, a stator is shown having axially extending cooling channels, wherein the cooling channels are arranged in the stator tooth and are fed from the center of the stator. In particular, the stator according to US2018054094 AA can be a laminated core.

The publication CN112104114 also shows a stator having a circumferentially meandering cooling channel which has axial sections.

### SUMMARY

The object of the disclosure is to provide an active component of an electric machine that is improved compared to the prior art. In particular, to provide an active component in which improved cooling performance is achieved. The further task is to provide an improved electric machine.

The object is achieved by the measures described in the independent claims. Further advantageous embodiments are described in the dependent claims.

According to one aspect, an active component of an electric machine has a cooling channel which, at least in sections, has a substantially axial extension which has a substantially constant cross-sectional area. Furthermore, the extension has a reducing element protruding into the extension, which is designed to reduce the cross-section in such a way that turbulence of the cooling fluid occurs when a cooling fluid flows therethrough.

The advantageous effect of this aspect is due to the fact that turbulent flows are formed by the reducing element with a corresponding flow of a cooling fluid. This is particularly advantageous because particularly large temperature gradients can be achieved when the flow is turbulent. This means the fluid can be mixed better and significantly more heat can be transported away from the wall. In particular, heat can be dissipated from the active component in the region of the extension. The reducing element protrudes particularly advantageously thereinto in a manner perpendicular to the direction of extension.

According to one embodiment, the reducing element reduces the cross-sectional area in the region of the reducing element by up to 20%. It is particularly advantageous if the reducing element reduces the cross-sectional area by up to 20%, since the associated pressure losses in the cooling channel are kept low. In a particularly advantageous embodiment, the reducing element reduces the cross-sectional area by up to 10%.

According to one embodiment, the active component has a laminated core. If the active component has a laminated core made of individual sheets, cooling channels can be particularly advantageously implemented as recesses in the sheet metal cut of the individual sheets. The individual sheets are stacked according to a predefined orientation and the recesses thus create a cooling channel.

According to one embodiment, the reducing element is formed integrally from a single sheet of the laminated core. The design is chosen such that the reducing element can be advantageously and easily realized as a sheet metal cut as an integral part of an individual sheet. It is particularly preferred if the reducing element is realized by a modification of the sheet metal cut in the region of the recess forming the cooling channel. The modification can expediently be designed in such a way that the reducing element is designed to be circumferential and thus the cross-sectional area is circumferentially reduced.

According to one embodiment, the reducing element comprises several immediately adjacent individual sheets. This is particularly advantageous if the reducing element has an axial length that is greater than the axial thickness of a single sheet.

According to one embodiment, the reducing element is arranged at a distal end of the extension. The reducing element is advantageously designed as an integral part of what is termed an end disk or balancing plate. The reducing element can expediently also be designed as an insertion sleeve, in particular having a stop.

According to one embodiment, the reducing element has a length in the axial direction of up to 5% of the length of the axial extent. Advantageously, the reducing element is a local reduction of the otherwise essentially constant cross-sectional area and is short with a length in the axial direction of up to 5% of the length of the axial extent. A comparatively short reduction in the cross-sectional area is sufficient to generate the advantageous turbulence and in particular the turbulent flow.

According to one embodiment, the extension has a deviation from the axial direction of up to 20°. The advantageous effect of the design results from slanted active components, in particular if the slanting takes place via a gradual rotation of the individual sheets relative to one another in the laminated core. Particularly advantageously, the extension then has a deviation from the axial direction, which describes a helix-shaped course, referred to as a bevel. The deviation is particularly preferably less than 10°.

According to one embodiment, the active component is a stator of the electric machine.

According to a further aspect, an electric machine comprises an active component according to the disclosure.

Both the disclosure and the technical field are explained in more detail below with reference to the figures. It should be noted that the disclosure is not intended to be limited by the exemplary embodiments shown. In particular, unless explicitly stated otherwise, it is also possible to extract partial aspects of the subject matter outlined in the figures and to combine them with other components and knowledge from the present description and/or figures. In particular, it should be noted that the figures and in particular the size relationships shown are only schematic in nature. Identical reference symbols indicate the same objects, so that, where applicable, explanations from other figures can also be used. Terms such as “radial”, “axial” or similar refer to the rotational axis of the electric machine, unless a different reference is explicitly used. Furthermore, to improve the readability of the figures, only individual or a few identical elements of a reference symbol are provided in some cases.

### BRIEF DESCRIPTION OF THE DRAWINGS

In the figures

FIG. 1 shows a perspective partial section and a schematic partial section through an active component designed as a stator according to the prior art

FIG. 2 shows several schematic partial sections of an active component designed as a stator

FIG. 3 shows alternative exemplary embodiments as schematic partial sections

FIG. 4 shows further alternative exemplary embodiments as schematic partial sections

FIG. 5 shows further alternative exemplary embodiments as a schematic partial view

FIG. 6 shows further alternative exemplary embodiments as a schematic partial view

### DESCRIPTION OF EMBODIMENTS

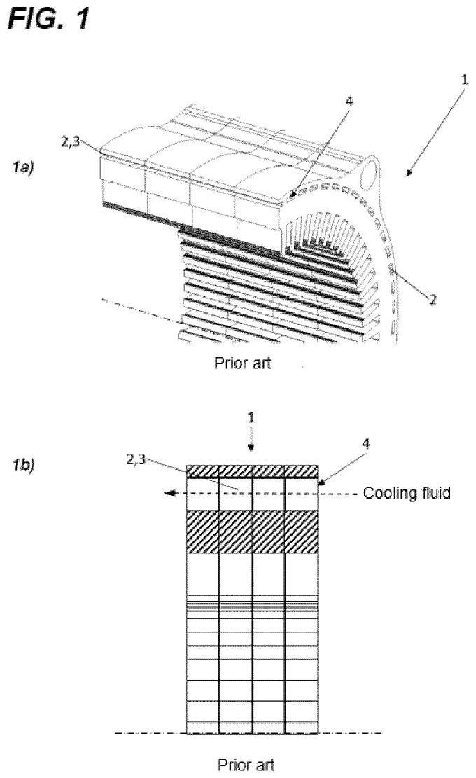

FIG. 1 shows a perspective partial section FIG. 1a) and a schematic partial section FIG. 1b) through an active component 1 designed as a stator according to the prior art. In the active component 1, several cooling channels 2 are formed around the circumference, each with a rectangular cross-sectional area. The active component 1 is composed in the axial direction of several of what are termed stacks, through which the cooling channels 2 each form an axial extension 3 with a constant cross-sectional area 4. In FIG. 1b, the flow direction of a cooling fluid in the cooling channel 2 is indicated as a dashed arrow.

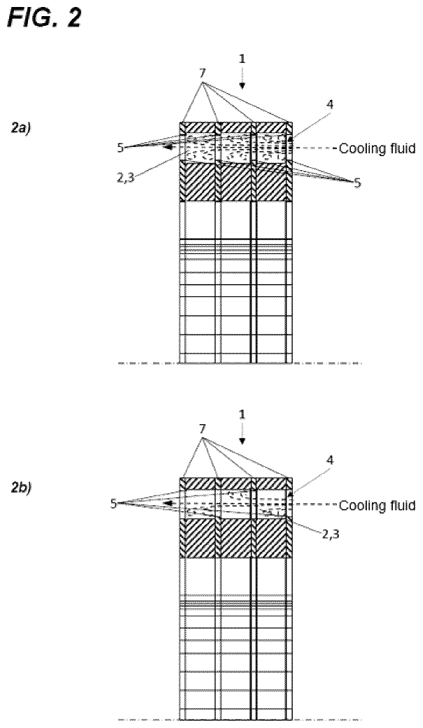

FIG. 2 shows several schematic partial sections FIG. 2a, FIG. 2b of an active component 1 designed as a stator.

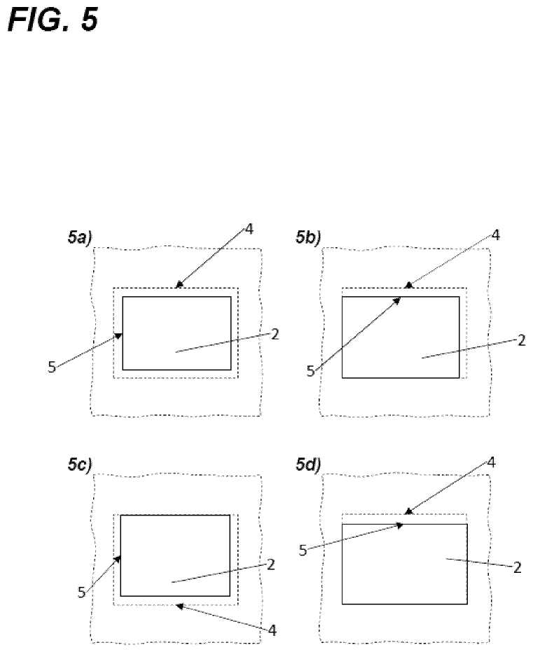

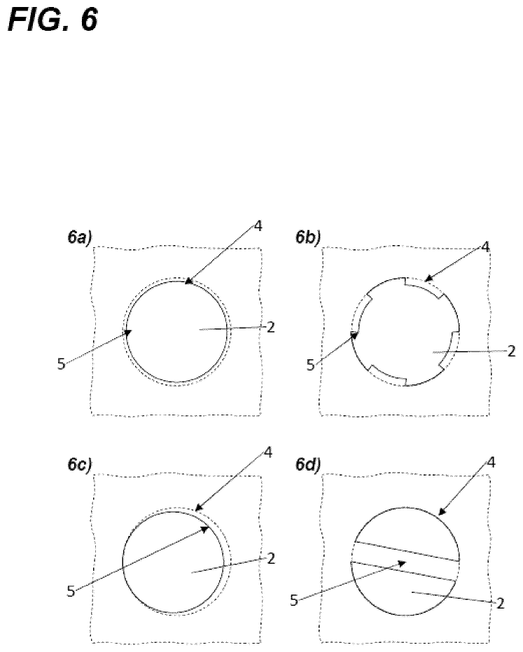

In FIG. 2a, individual sheets 7 designed as end disks or balancing plates are arranged at the distal ends of the active component 1, and individual sheets 7 are arranged between the individual stacks, each of which integrally forms reducing elements 5 which protrude thereinto in the same manner perpendicular to the direction of extension 3. The reducing elements 5 protrude in the cutting plane both on the radially inner side of the cooling channel 2 or the extension 3 radially outwards into the extension 3 and on the radially outer side of the cooling channel 2 or the extension 3 radially inwards into the extension 3. The reducing elements can be designed to be circumferential according to FIG. 5a and FIG. 6a.

In FIG. 2b, individual sheets 7 designed as end disks or balancing plates are arranged at the distal ends of the active component 1, as well as individual sheets 7 between the individual stacks, which each integrally form reducing elements 5 which protrude thereinto in the same manner perpendicular to the direction of extension 3. The reducing elements 5 alternately protrude from the radially inner side of the cooling channel 2 or the extension 3 radially outwards into the extension 3 and on the radially outer side of the cooling channel 2 or the extension 3 radially inwards into the extension 3. The reducing elements can be designed according to FIG. 5b, FIG. 5c, FIG. 5d.

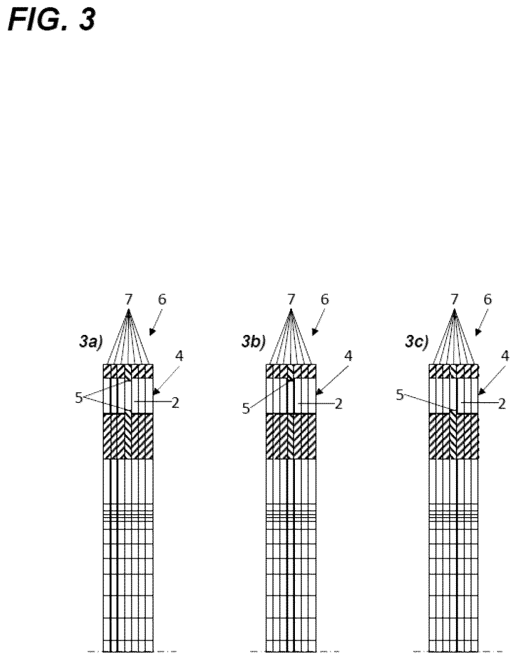

FIG. 3 shows alternative exemplary embodiments as schematic partial sections. In the exemplary embodiments, a stack of an active component 1 is shown as a laminated core 6 consisting of individual sheets 7.

FIG. 3a shows several individual sheets 7 which form a laminated core 6 of an active component 1, wherein an individual sheet 7 is arranged within the laminated core 6 which integrally forms a reducing element 5, which protrudes thereinto in a manner perpendicular to the direction of the extension 3. The reducing element 5 protrudes, in the cutting plane both on the radially inner side of the cooling channel 2 or the extension 3, radially outwards into the extension 3 and, on the radially outer side of the cooling channel 2 or the extension 3, radially inwards into the extension 3.

FIG. 3b shows several individual sheets 7 which form a laminated core 6 of an active component 1, wherein an individual sheet 7 is arranged within the laminated core 6 which integrally forms a reducing element 5, which protrudes thereinto in a manner perpendicular to the direction of the extension 3. The reducing element 5 protrudes in the cutting plane on the radially outer side of the cooling channel 2 or the extension 3 radially inwards into the extension 3.

FIG. 3c shows several individual sheets 7 which form a laminated core 6 of an active component 1, wherein an individual sheet 7 is arranged within the laminated core 6 which integrally forms a reducing element 5, which protrudes thereinto in a manner perpendicular to the direction of the extension 3. The reducing element 5 protrudes radially outwards into the extension 3 in the sectional plane on the radially inner side of the cooling channel 2 or the extension 3.

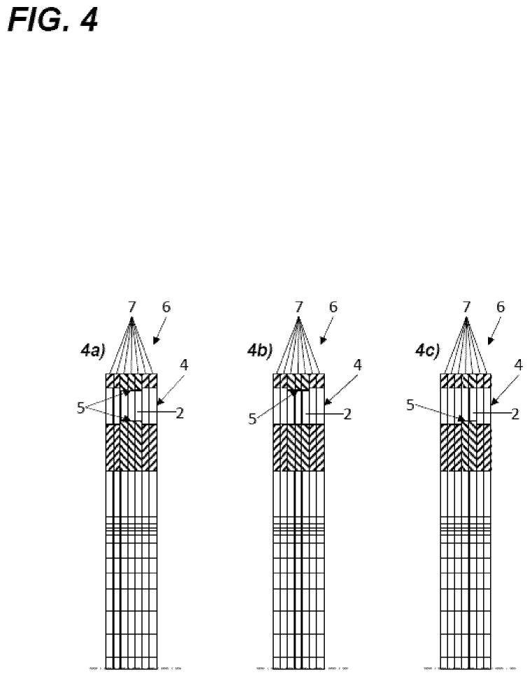

FIG. 4 shows further alternative exemplary embodiments as schematic partial sections. In contrast to the exemplary embodiments in FIG. 3, the reducing elements 5 in the exemplary embodiments in FIG. 4 are each formed from several adjacent individual sheets 6.

FIG. 5 and FIG. 6 show further alternative exemplary embodiments as a schematic partial view, wherein in each case a reducing element 5 is shown with respect to the cross-sectional area 4 of the cooling channel. Since the cross-sectional area 4 in the image plane is partially covered by the reducing element 5, a dashed line was chosen for the hidden edge, as is common in technical drawings. The shapes shown are exemplary and not limited to the exemplary embodiments shown below.

FIGS. 5a to 5d each show partial views of cooling channels 2 with a rectangular cross-sectional area 4. In FIG. 5a, the reducing element 5 protrudes into the cooling channel 2 over the entire circumference of the cross-sectional area 4. In FIG. 5b, the reducing element 5 protrudes into the cooling channel 2 on two adjacent sides, the remaining sides are congruent with the corresponding sides of the cross-sectional area 4.

In FIG. 5c, the reducing element 5 protrudes into the cooling channel 2 on three adjacent sides, the remaining side is congruent with the corresponding side of the cross-sectional area 4. In FIG. 5d, the reducing element 5 protrudes into the cooling channel 2 on one side, the remaining sides are congruent with the corresponding sides of the cross-sectional area 4.

FIGS. 6a to 6d each show partial views of cooling channels 2 with a round cross-sectional area 4. In FIG. 6a, the reducing element 5 protrudes into the cooling channel 2 over the entire circumference of the cross-sectional area 4. The inner edge of the reducing element 5 and the circumference of the cross-sectional area 4 are arranged to be concentric.

In FIG. 6b, the reducing element 5 protrudes in sections over the circumference of the cross-sectional area 4 into the cooling channel 2. The inner edge of the reducing element 5 and the circumference of the cross-sectional area 4 are arranged to be concentric.

In FIG. 6c, the reducing element 5 protrudes essentially over the entire circumference of the cross-sectional area 4 into the cooling channel 2. The inner edge of the reducing element 5 and the circumference of the cross-sectional area 4 are not arranged to be concentric.

In FIG. 6d, the reducing element 5 forms a region that centrally covers the cross-sectional area 4.

### LIST OF REFERENCE SYMBOLS

1. Active component
2. Cooling duct
3. Extent1
4. Cross-sectional area
5. Reducing element
6. Laminated core
7. Individual metal sheet

1. An active component of an electric machine having a cooling channel, which, at least in some portions, has a substantially axial extension which has a substantially constant cross-sectional area,
characterized by
a reducing element protruding into the extension, which is designed to reduce the cross-sectional area in such a way that turbulence of the cooling fluid occurs when a cooling fluid flows therethrough.

2. The active component according to claim 1, wherein the reducing element reduces the cross-sectional area in the region of the reducing element by up to 20%.

3. The active component according to claim 1, wherein the active component has a laminated core.

4. The active component according to claim 3, wherein the reducing element is formed integrally from a single sheet of the laminated core.

5. The active component according to claim 4, wherein the reducing element comprises several immediately adjacent individual sheets.

6. The active component according to claim 1, wherein the reducing element is arranged at a distal end of the extension in the axial direction.

7. The active component according to claim 1, wherein the reducing element has a length in the axial direction of up to 5% of the length of the axial extension.

8. The active component according to claim 1, wherein the extension has a deviation from the axial direction of up to 20°.

9. The active component according to claim 1, wherein the active component is a stator of the electric machine.

10. An electric machine comprising an active component according to claim 1.

11. An active component of an electric machine comprising:
a reducing element protruding into an axial extension of a cooling channel of the active component of the electric machine, wherein the reducing element is configured to reduce a cross-sectional area of the to generate turbulence within the cooling fluid when the cooling fluid flows through the axial extension.

12. The active component according to claim 1, wherein the reducing element reduces the cross-sectional area in the region of the reducing element by up to 20%.

13. The active component according to claim 1, wherein the active component has a laminated core.

14. The active component according to claim 3, wherein the reducing element is formed from a single sheet of the laminated core.

15. The active component according to claim 3, wherein the reducing element comprises a plurality of adjacent sheets of the laminated core.

16. The active component according to claim 1, wherein the reducing element is arranged at a distal end of the extension in the axial direction.

17. The active component according to claim 1, wherein the reducing element has a length in the axial direction of up to 5% of the length of the axial extension.

18. The active component according to claim 1, wherein the extension has a deviation from the axial direction of up to 20°.

19. An electric machine comprising:
an active component, wherein the active component comprises a reducing element protruding into an axial extension of a cooling channel of the active component of the electric machine, wherein the reducing element is configured to reduce a cross-sectional area of the to generate turbulence within the cooling fluid when the cooling fluid flows through the axial extension.

20. The electric machine of claim 19, wherein the active component comprises a stator of the electric machine.
